(19) United States
(12) Patent Application Publication
(10) Pub. No.: US 2011/0199661 A1
(43) Pub. Date: Aug. 18, 2011

(54) COCKPIT FOR AN AIRCRAFT

(75) Inventors: Wolfgang Kreitmair-Steck, Ottobrunn (DE); Stefan Haisch, Ottobrunn (DE)

(73) Assignee: EUROCOPTER DEUTSCHLAND GMBH, Donauworth (DE)

(21) Appl. No.: 13/023,758

(22) Filed: Feb. 9, 2011

(30) Foreign Application Priority Data
Feb. 18, 2010 (EP) 10 400009.6

(51) Int. Cl. G02B 27/01; G02F 1/01; G03H 1/00

(52) U.S. Cl. 359/13; 359/245

(57) ABSTRACT

The invention relates to a cockpit for an aircraft, particularly for a helicopter, with transparent extensions (2, 3) to a dashboard (7) for displaying various control information for flight operation. The transparency of the extensions (2, 3) of the dashboard (7) is automatically or via pilot commands changeable depending on flight operations and environmental needs.

### CROSS REFERENCE TO RELATED APPLICATIONS

This application claims the benefit of EP 10 400009.6 filed on Feb. 18, 2010, the disclosure of which is incorporated in its entirety by reference herein.

### BACKGROUND OF THE INVENTION

1. Field Of The Invention

The invention relates to a cockpit for an aircraft, such as, but not limited to a helicopter.

2. Description Of Related Art

Dashboards in cockpits of conventional aircrafts are covering a broad range of the pilot's view to the outside this being particularly disadvantageous for landings and take-offs during which the view to the outside is of special relevance for the pilot and/or the crew onboard.

A modern airplane like the A400M is provided with two HUD=Head up Display. These HUD are designed with lucent guidance displays replacing Primary Flight Display (PFD). With HUD the pilot may use the head down displays for different purposes than guidance. A400M allows the pilot to select the information to be presented on the display and the pilot may arrange the displays according to the priorities of the flight situation.

DE 19704740 A1 discloses a holographic display screen for laser projection of at least one or more laser wavelengths, which selectively diffuses the incident narrow-band laser beam at a predetermined solid angle and simultaneously lets the wide-band ambient light through unobstructed. Said display screen—for use in cockpits of aircrafts and vehicles—has at least one holographic phase grid which is optically coupled to a transparent backing plate. The resulting holographic display screen may be tuned with respect to the distribution of brightness and may be focused to endless. The displays of this holographic display screen can not be operated and controlled independently and they have a relatively high consumption of electrical power.

### SUMMARY OF THE INVENTION

It is an object of the present invention to provide for a cockpit of an aircraft particularly a cockpit for a helicopter allowing better visibility for the pilot to the exterior of the cockpit and avoiding the disadvantages of the state of the art.

A solution is provided with a cockpit with the features of claim 1. Preferred embodiments of the invention are presented in the subclaims.

According to the invention a cockpit for an aircraft is provided with a windscreen and a dashboard. At least one extension of the dashboard is provided preferably being added laterally to the dashboard with at least a part of these extensions being transparent. At least one optical element is provided for creating at least one virtual image, namely a display on the transparent extension of the dashboard. The transparency of the extension is adjustable to match detected specific flight situations and/or ambient light intensity. The invention relates to a cockpit for an aircraft, particularly for a helicopter, with transparent displays for various control tools for flight operation. The displays on the transparent extension may be used to present important information to the pilot thus substituting the display of information on the dashboard and consequently allowing the installation of a less bulky dashboard in the cockpit. The transparency of the extension is changeable automatically or via pilot commands depending on flight operations and environmental needs such that the information may be presented partly transparent or opaque. The invention has the advantage of allowing large area displays preferably in landscape format for optimized information of the pilot inside the cockpit without impeding the sight of the pilot out of the cockpit onto the landscape ahead particularly without hindering the sight of the pilot by the dashboard to the airfield for take-off and landing. The displays can be presented independently and the displays on the adjustably transparent extensions can be operated with little electric consumption, particularly if the display is limited to a predefined, restraint area of visibility as may be appropriate for displays dedicated to the pilot's exclusive use.

According to a preferred embodiment of the invention at least a part of the transparent area of the dashboard comprises at least one pane of glass with such panes being mounted laterally to at least one side of the dashboard.

According to a further preferred embodiment of the invention a windscreen is provided with at least a part of the piloting information being projected into this windscreen for improved situation awareness e.g. visibility from the cockpit to the surrounding of the helicopter while the transparent dashboard is displaying various control tools for flight operation.

According to a further preferred embodiment of the invention at least a part of the extension of the dashboard is made of preferably electrically adjustable transparent material with the transparency of the dashboard being changeable automatically or via pilot commands.

According to a further preferred embodiment of the invention the virtual image is created by projection, e. g. holographic, conventional or by overlaying a transparent foil display onto the adjustable transparent material made of LED, particularly OLED technology, allowing separate operation and control of each display with consequent possibilities of redundant system-design as well as very low display weight. Projection from behind onto a holographic display area according to the invention has the advantage of allowing the limitation of the information onto a defined area of sight with the possibility of saving electrical power and allows focusing to infinity with remarkable advantages on behalf of the pilot as to the reduced necessity for adaption of the eyes of the pilot.

According to a further preferred embodiment of the invention the extension of the dashboard is provided with touch-screen functions for push buttons.

According to a preferred embodiment of the invention the adjustably transparent area is exclusively arranged on the pilot's side or on the left-hand and right-hand side with respect to the central area. In a flight situation such as take-off or landing, during which the pilot is supposed to pay special attention to the surrounding outside, the visibility of the displays on the dashboard may be adjusted to an extent that allows the pilot to recognize the landscape through the adjustably transparent extensions of the windscreen/dashboard of the cockpit. Control of the discernibility may be provided automatically by the system of the helicopter and/or may be tuned or overruled by the pilot. In flight situations, during which the surrounding outside is less interesting such as for example at cruising operations in safe heights, the displays may be tuned to dark and the respective brightness of the displays may be adapted.

According to a preferred embodiment of the invention at least one optical element directing light to the respective transparent area of the extension(s) of the dashboard is arranged centrally in the mid-area of the dashboard.

A preferred embodiment of the invention is presented in the attached drawing.

### BRIEF DESCRIPTION OF THE DRAWINGS

FIG. 1 shows a cockpit according to the invention.

### DETAILED DESCRIPTION OF THE PREFERRED EMBODIMENT

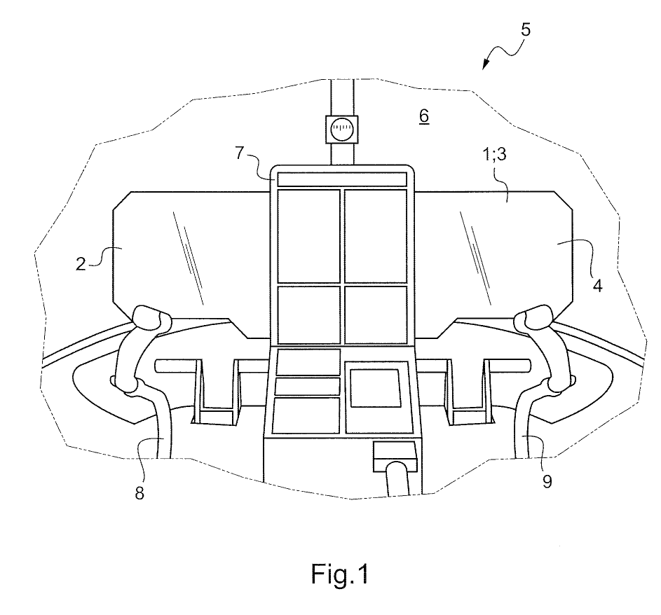

In FIG. 1, there is a cockpit 5 of a helicopter with a windscreen 6 and a centrally arranged dashboard 7 with instruments, displays and control devices. Control columns 8, 9 are provided on either side of the dashboard 7. The dashboard 7 is provided with extensions 10, 11 mounted laterally to either side of the dashboard 7. The extensions 2, 3 comprise a pane of glass. The extensions 2, 3 are provided with an adjustably transparent area 1 with an eclipsed information (not shown) and an eclipsed display (not shown) as virtual images provided from an optical element (not shown) directing light to the adjustably transparent area 1 made of electrically adjustable transparent glass.

The virtual images are either created on the adjustably transparent area 1 by projection from behind onto the transparent area 1, e. g. holographic. Virtual images provided by holographic means are infinitely focused in the direction of view of the pilot, i.e. focused to at least more than 5 m or the adjustably transparent area 1 may be made by a conventional technique e.g. LED or the like or equipped with transparent displays of foil(s) made of LED-, particularly OLED-technology.

The display is provided as Primary Flight Display or Synthetic Vision Display. A push button 4 is provided by touch-screen means on the adjustably transparent area 1 and/or on the dashboard 7.

The information display to the pilot by the extensions 2, 3 with the adjustably transparent area 1 may be improved by a projection of additional information into the windscreen 6.

The information and display may be tuned up to entirely transparent by a pilot of the helicopter or may be automatically adapted by an onboard control depending from the relevance or the needs of the situation.

The representation of a landscape in the display or on the windscreen from a point of view of the pilot may be tuned in a way to be congruent with the landscape outside and is focused at infinity in order to provide an optimized variation between external sight or more sight directly onto the display for less change/adaption of the eyes of the pilot between external sight and display information. In case of congruent landscape and representation a semi-transparent setting of the display information may be suitable.

What is claimed is:

1. A cockpit for an aircraft, particularly for a helicopter, with a dashboard and at least one extension of the dashboard, characterized in that the at least one extension of the dashboard is provided with at least one partly transparent area and in that the transparency of this transparent area of the at least one extension is adjustable.

2. A cockpit according to claim 1, wherein at least a part of the transparent area of the dashboard comprises a pane of glass.

3. A cockpit according to claim 1, wherein a windscreen is provided with at least a part of the transparent area of the dashboard being integrated into this windscreen.

4. A cockpit according to claim 1, wherein the transparent area of the dashboard is made of preferably electrically adjustable transparent material.

5. A cockpit according to claim 1, wherein a control is provided for automatic adjustment of the transparency the control being apt to be overruled by the pilot.

6. A cockpit according to claim 1, wherein at least one virtual image is created by projection onto the transparent area of the extensions to the dashboard, e. g. holographic, conventional or by LED, particularly OLED technology.

7. A cockpit according to claim 6, wherein at least a part of the at least one virtual image is infinitely focused.

8. A cockpit according to claim 1, wherein touch-screen functions are provided in the transparent area of the extensions of the dashboard.

9. A cockpit according to claim 1, wherein the transparent area of the extensions of the dashboard is exclusively arranged on the pilot's side or on the left-hand and right-hand side with respect to a central area.

10. A cockpit according to claim 1, wherein at least one optical element is arranged centrally in a mid-area of the dashboard directing light to the transparent area of the dashboard.
